(19) United States
(12) Patent Application Publication
(10) Pub. No.: US 2008/0303515 A1
(43) Pub. Date: Dec. 11, 2008

(54) Position sensor

(76) Inventors: Ronald J. Wolf, Elkhart, IN (US); Max W. Garwood, Huntington, IN (US)

Correspondence Address: Max W. Garwood, 450 N. Jefferson Street, P.O. Box 30, Huntington, IN, 46750, US

(21) Appl. No.: 11/810,298

(22) Filed: Jun. 5, 2007

(51) Int. Cl. G01B 7/14

(52) U.S. Cl. 324/207.24

(57) ABSTRACT

A position sensor including at least one magnet producing a magnetic field, at least one magnetic flux sensing device sensing the magnetic field, and a ferrous sleeve. The ferrous sleeve being rotatable about a longitudinal axis of the magnet. The magnetic field detected by the magnetic flux sensing device being substantially unaffected by rotation of the ferrous sleeve relative to the magnet.

### BACKGROUND OF THE INVENTION

1. Field of the Invention

The present invention relates to a position sensor, and, more particularly, to a rotatable linear position sensor.

2. Description of the Related Art

Electronic devices are an increasing part of everyday life and they are presently integrated in a large number of products, including products traditionally thought of as mechanical in nature, such as automobiles. To bridge the gap between mechanical movement and electronic control, it is necessary to successfully integrate electronic and mechanical components. This gap is normally bridged by using devices such as sensors and actuators.

Position sensors are used to electronically monitor the position or movement of a mechanical component. The position sensor produces data that may be expressed as an electrical signal that varies as the position of the mechanical component changes. Position sensors are an important part of innumerable products, providing the opportunity for intelligent control of a mechanical device.

Various contact-type sensors are known. For example, potentiometers are used, which detect a change in electrical signal due to a physical change in position of a wiping contact on an electrical resistive element. Rotational position movement can be detected by coupling a shaft of a potentiometer to the shaft of a rotating mechanical component. Linear movement can be detected either using a linear potentiometer or a rotating potentiometer that is coupled to a linear-moving component using pulleys and a string or a belt to translate a linear motion to rotational motion. A problem with this type of sensor is the physical wearing of the contacting parts. The wiping contact and the resistive element can cause a drift in the electrical signal, which induces errors and may lead to ultimate failure of the device.

Magnetic velocity sensors are generally a non-contact type of sensor and consist of a magnetic field sensing device, which is usually stationary, and a magnet is attached to a moving component. As the magnet approaches the sensing device, the magnetic field of the magnet is detected and the sensing device generates an electrical signal that is then used for counting, displaying, recording and/or control purposes.

What is needed in the art is a linear position sensor that is substantially unaffected by a rotation of a component.

### SUMMARY OF THE INVENTION

The present invention provides a linear position sensor that is insensitive to the rotation of portions thereof.

The invention comprises, in one form thereof, a position sensor including at least one magnet producing a magnetic field, at least one magnetic flux sensing device sensing the magnetic field, and a ferrous sleeve. The ferrous sleeve being rotatable about a longitudinal axis of the magnet. The magnetic field detected by the magnetic flux sensing device being substantially unaffected by rotation of the ferrous sleeve relative to the magnet.

An advantage of the present invention is that the magnet can be rotatable about a longitudinal axis yet the sensor can sense the linear longitudinal position of the magnet.

Another advantage of the present invention is that in addition to the rotation of the magnet, the sleeve that somewhat encompasses the magnet can be rotatable relative to the magnet without affecting the linear position detection thereof.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematical cross-sectional view of an embodiment of a position sensor of the present invention;

FIG. 2 Shows the position sensor of FIG. 1 with the rotatable sleeve in a an alternate position;

FIG. 3 is a position sensor of FIGS. 1 and 2 with the rotatable sleeve in yet another position;

FIG. 4 is a schematical cross-sectional view of another embodiment of the position sensor of the present invention;

FIG. 5 is the position sensor of FIG. 4 with the magnet in an altered position;

FIG. 6 is the position sensor of FIGS. 4 and 5 with the magnet sensor in yet another alternate position;

FIG. 7 illustrates one alternative shape of the sleeve used in FIG. 1-6; and

FIG. 8 is another embodiment of a sleeve that can be used in position sensor of FIGS. 1-6.

Corresponding reference characters indicate corresponding parts throughout the several views. The exemplification set out herein illustrates a preferred embodiment of the invention, and such exemplifications are not to be construed as limiting the scope of the invention in any manner.

### DETAILED DESCRIPTION OF THE PRESENT INVENTION

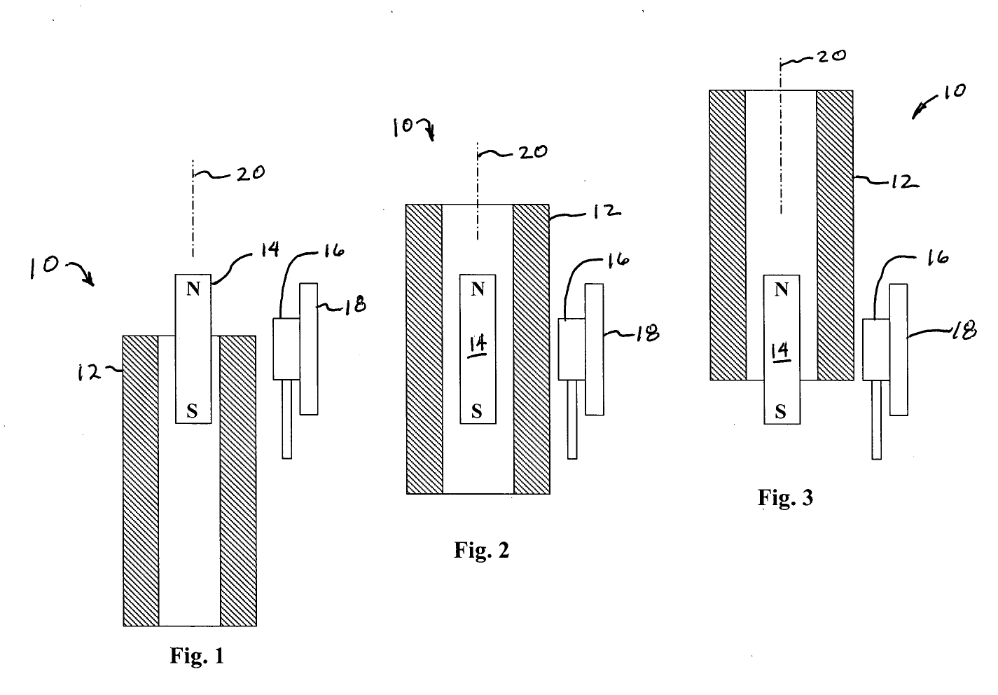

Referring now to the drawings, and more particularly to FIGS. 1-3, there is shown an embodiment of a position sensor assembly 10 including a sleeve 12, a magnet 14, and magnetic flux sensor 16, a plate 18, and a longitudinal axis 20. For the ease of illustration, mechanical and electrical couplings to various items are not illustrated so the invention may be more easily understood.

Sleeve 12 is movable in a longitudinal direction, and is movable relative to the magnet 14 and magnetic flux sensor 16 as illustrated in three different views shown in FIGS. 1-3 when sleeve 12 is shown as moving in a linear manner in a longitudinal direction relative to longitudinal axis 20. As sleeve 12 moves and changes position relative to magnet 14 and to magnetic flux sensor 16, the magnetic flux detected by magnetic flux sensor 16 is altered since sleeve 12 is made of a material, such as a ferrous material, that will tend to alter the amount of magnetic flux detected by magnetic flux sensor 16. Sleeve 12 may also alter the direction of magnetic flux that can be detected by flux sensor 16 as well. The position of sleeve 12 is detected relative to its linear position in the longitudinal direction 20. Sleeve 12 is rotatable about magnet 14 likewise magnet 14 may be rotating as well. Even though sleeve 12 and sleeve 14 may be rotating relative to each other, the linear position of sleeve 12 is determined by the effect of the magnetic flux detected by magnetic flux detector 16. Axis 20 illustrates the longitudinal axis of magnet 14 which may be substantially parallel to the longitudinal axis of sleeve 12. As can be seen in FIG. 1, sleeve 12 is offset slightly to the left so that an axis of sleeve 12 is substantially parallel to axis 20 but also offset slightly to the left from axis 20. Again, even in this condition, if sleeve 12 is rotating about an axis that is substantially parallel to axis 20 the linear position of sleeve 12 is still detected without being disturbed by the rotation of either magnet 14 or sleeve 12. In FIG. 2, axis 20 illustrates a co-linear positioning of the axis of sleeve 12 and magnet 14. Magnetic flux detector 16 has a substantially linear electrical output, which is representative of the position of sleeve 12 relative to magnet 14. In order to improve the signal, ferrous plate 18 is positioned and may extend in a curvilinear fashion relative to the surface of sleeve 12 in a non-contacting manner.

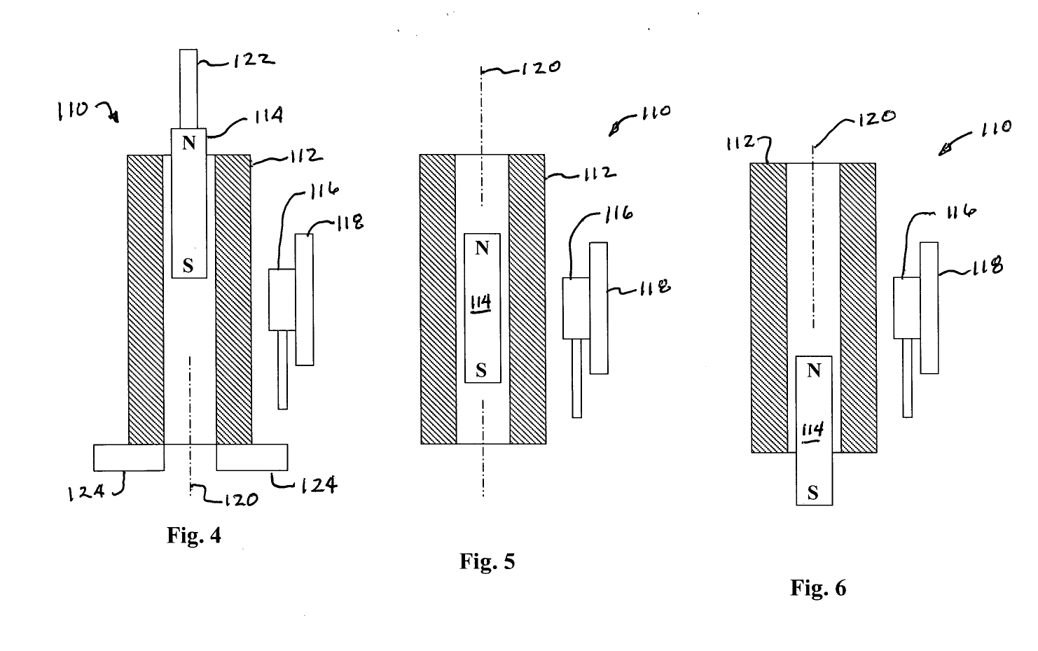

Now, additionally referring to FIGS. 4-6, there is illustrated another embodiment of the present invention wherein the reference numbers are incremented by 100 yet refer to substantially similar items where magnet 114 is now movable relative to sleeve 112 along axis 120 as illustrated in FIGS. 4-6. As magnet 114 is rotated by structural member 122, sleeve 112 may also be rotating about axis 120 as it is attached to structure 124. As the movement of magnet 114 along longitudinal axis 120 occurs, magnetic sensing device 116 detects the movement of magnet 114 along longitudinal axis 120 and provides a linear electrical signal output representative of the positioning of magnet 114 relative to magnet flux sensing device 116. As in the previous embodiment, plate 118 may be a ferrous plate, which serves to direct or enhance the signal received by magnet flux sensing device 116.

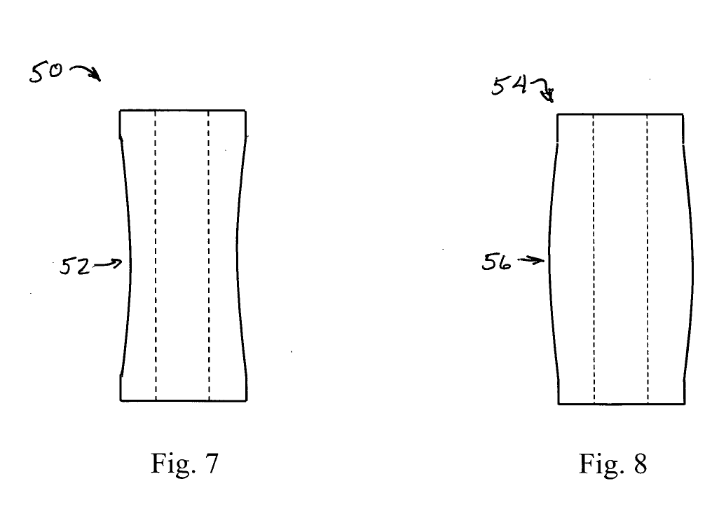

Now, additionally referring to FIGS. 7 and 8, there are shown ferrous sleeves 50 and 54 having shaped attributes of a concave surface 52 or a convex surface 56. To illustrate the manner in which a sleeve 12 or 112 may be shaped to alter the magnetic flux detected by the magnetic flux sensing devices 16 and 116.

There is also contemplated that multiple magnetic flux sensing devices 16 or 116 may be positioned at other points along the travel of sleeve 12 or magnet 114. The electronic circuitry connected to magnetic flux sensing device 16 or 116 to convey signals therefrom are also contemplated in the embodiment of the present invention.

While this invention has been described with respect to preferred embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A position sensor, comprising:
at least one magnet producing a magnetic field;
at least one magnetic flux sensing device sensing said magnetic field; and
a ferrous sleeve rotatable about a longitudinal axis of said magnet, said magnetic field detected by said magnetic flux sensing device being substantially unaffected by rotation of said ferrous sleeve relative to said magnet.

2. The position sensor of claim 1, wherein said ferrous sleeve has a longitudinal axis, said ferrous sleeve being movable along said longitudinal axis.

3. The position sensor of claim 2, wherein said longitudinal axis of said magnet is substantially parallel to said longitudinal axis of said ferrous sleeve.

4. The position sensor of claim 3, wherein said longitudinal axis of said magnet is co-linear with said longitudinal axis of said ferrous sleeve.

5. The position sensor of claim 2, wherein said ferrous sleeve rotates about said longitudinal axis.

6. The position sensor of claim 1, wherein said magnet has a longitudinal axis, said magnet being movable along said longitudinal axis.

7. The position sensor of claim 6, wherein said ferrous sleeve has a first end and a second end, said magnet movable at least from said first end to said second end.

8. The position sensor of claim 6, wherein said ferrous sleeve has a longitudinal axis substantially parallel to said longitudinal axis of said magnet.

9. The position sensor of claim 8, wherein said longitudinal axis of said magnet is collinear with said longitudinal axis of said ferrous sleeve.

10. The position sensor of claim 8, wherein said ferrous sleeve is rotatable about said longitudinal axis.

11. The position sensor of claim 6, wherein said magnet is rotatable about said longitudinal axis.

12. A position sensor, comprising:
a magnet;
at least one magnetic flux sensing device in a fixed position relative to said magnet; and
a ferrous sleeve rotatable about said magnet.

13. The position sensor of claim 12, wherein said ferrous sleeve has a longitudinal axis, said ferrous sleeve being movable along said longitudinal axis.

14. The position sensor of claim 13, wherein said magnet has a longitudinal axis substantially parallel to said longitudinal axis of said ferrous sleeve.

15. The position sensor of claim 14, wherein said longitudinal axis of said magnet is co-linear with said longitudinal axis of said ferrous sleeve.

16. The position sensor of claim 13, wherein said magnet is rotatable about said longitudinal axis.

17. A position sensor, comprising:
a magnet;
a ferrous sleeve, said magnet and said ferrous sleeve rotatable relative to each other; and
at least one magnetic flux sensing device in a fixed position relative to a linear position of said ferrous sleeve.

18. The position sensor of claim 17, wherein said magnet has a longitudinal axis, said magnet being movable along said longitudinal axis.

19. The position sensor of claim 18, wherein said ferrous sleeve has a longitudinal axis, said longitudinal axis of said magnet being substantially parallel to said longitudinal axis of said ferrous sleeve.

20. The position sensor of claim 17, wherein said magnet is rotatable about said longitudinal axis.
